(19) United States
(12) Patent Application Publication
(10) Pub. No.: US 2023/0139086 A1
(43) Pub. Date: May 4, 2023

(54) NEGATIVE-PRESSURE MASSAGE MACHINE WITH EMBEDDED FILTER

(71) Applicant: BIBOTING INTERNATIONAL CO., LTD., Taoyuan City (TW)

(72) Inventors: Shih-Ta LIU, TAOYUAN CITY (TW); Po-Chang LIU, TAOYUAN CITY (TW); Pei-En LEE, New Taipei City (TW)

(21) Appl. No.: 17/515,378

(22) Filed: Oct. 29, 2021

(51) Int. Cl. A61H 7/00; A61H 15/00

(52) U.S. Cl. CPC A61H 7/008; A61H 15/00; A61H 2015/0014; A61H 2201/013; A61H 2201/16

(57) ABSTRACT

A negative-pressure massage machine includes a main body and an embedded filter. The main body has a panel with an installing hole. The embedded filter includes a hollow cylinder and a filter element disposed in the hollow cylinder. The hollow cylinder is assembled or removed corresponding to the installing hole from the outside of the panel. Therefore, the ventilation may be performed with a filter assuredly when a user is operating, and the degree of dirtiness of the filter may be easily viewed and the filter may be replaced conveniently.

### BACKGROUND

### Technical Field

The disclosure relates to a negative-pressure massage machine, particularly to a negative-pressure massage machine with an embedded filter.

### Related Art

With the faster and faster rhythm of life, people usually do not have enough time to relax or need to release accumulated pressure. Thus, there are many massage machines in the market. A related-art negative-pressure massage device includes a host, a soft tube, and a vacuum cup. Two ends of the soft tube separately connect to the host and the vacuum cup. A user may control the vacuum cup by the host to suck air from the skin or eject air on the skin so as to accomplish the effect of massage and relaxation.

Because the negative-pressure massage device is usually used with essential oil or lotion, a filter is provided outside the soft tube or in the pipeline of the host to prevent the essential oil or lotion from entering the host. However, the external filter may not be installed by the user and that causes infiltrating of essential oil or lotion to the host. The degree of dirtiness of the inside filter cannot be viewed from the outside and replacement is hard to perform. In addition, the related-art filter uses a common passage during sucking and ejecting air, so the essential oil or lotion in the filter core may be ejected to the user’s skin when ejecting air.

In view of this, the inventors have devoted themselves to the above-mentioned related art, researched intensively and cooperated with the application of science to try to solve the above-mentioned problems.

### SUMMARY

An object of the disclosure is to ensure that the ventilation is incorporated with a filter when a user is operating, and to make the degree of dirtiness of the filter be easily viewed and the filter be replaced conveniently.

To accomplish the above object, the disclosure provides a negative-pressure massage machine with an embedded filter, which includes a main body and an embedded filter. The main body has a panel with an installing hole. The embedded filter includes a hollow cylinder and a filter element disposed in the hollow cylinder. The hollow cylinder is assembled or removed corresponding to the installing hole from the outside of the panel.

The disclosure further has the following functions. By the hollow cylinder with transparent material, a user may directly view the degree of dirtiness of the filter element from the outside. The holding ribs on an inner wall of the hollow cylinder may increase the friction against the filter element to avoid unexpected separation. Rotating the embedded filter may make each latching lug latched in corresponding one of the locking recesses so as to fasten the embedded filter in the adapter. The first magnetic element of the engaging portion and the second magnetic elements of the connecting portion attract each other so that the embedded filter is easily connected to or separated from the adapter. The air sealing ring and the rubber ring may effectively seal up the embedded filter to avoid leakage when sucking and ejecting air.

### BRIEF DESCRIPTION OF THE DRAWINGS

FIG. 1 is a perspective view of the disclosure;

FIG. 2 is an exploded view of the main body and the embedded filter of the disclosure;

FIG. 3 is an exploded view of the adapter and the embedded filter of the disclosure;

FIG. 4 is an exploded view of the embedded filter of the disclosure;

FIG. 5 is another exploded view of FIG. 4;

FIG. 6 is a perspective view of the inside of the main body of the disclosure;

FIG. 7 is a cross-sectional view of the adapter and the embedded filter of the disclosure;

FIG. 8 is another cross-sectional view of the adapter and the embedded filter of the disclosure; and

FIG. 9 is an exploded view of the main body and the embedded filter of another embodiment of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

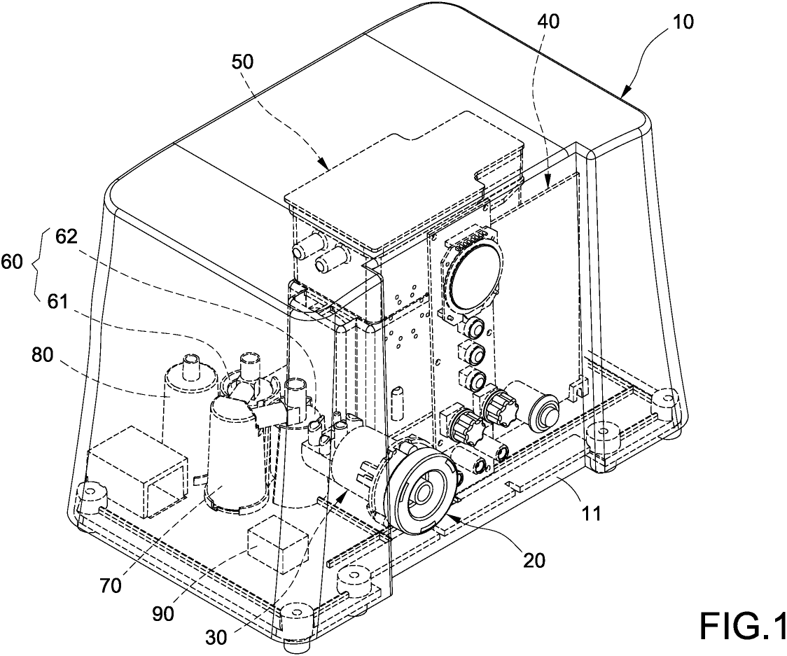

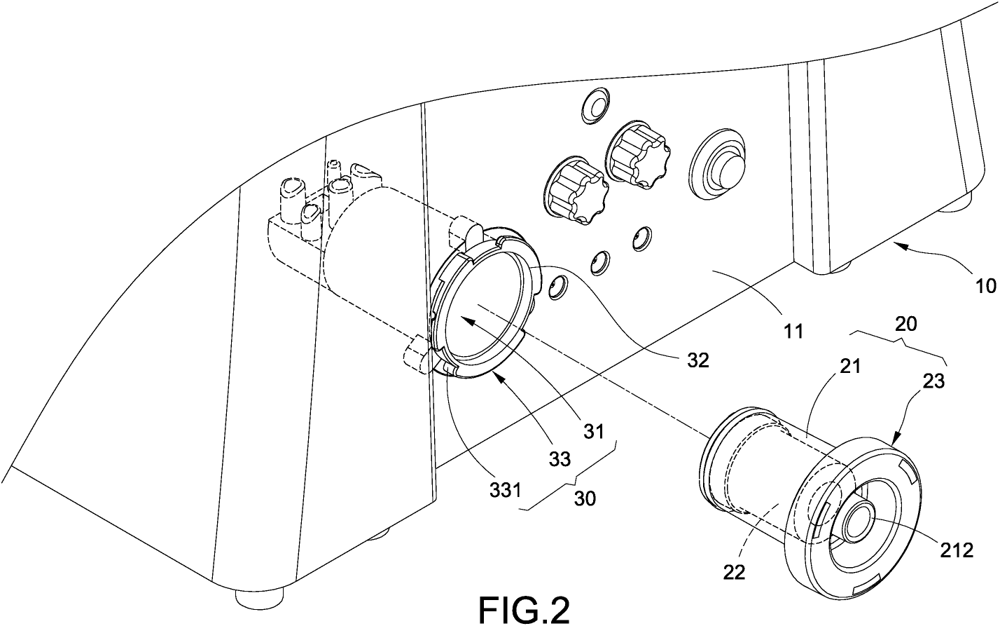

The disclosure provides a negative-pressure massage machine with an embedded filter 20, which is used with a soft tube (not shown in figures) and a vacuum cup (not shown in figures). Please refer to FIGS. 1-4. The massage machine includes a main body 10 and an embedded filter 20.

The main body 10 is substantially a trapezoid. A front side of the main body 10 has a panel 11 with an installing hole 111. In the embodiment, the panel 111 is further provided with a knob, a key, a buzzer, a display, a switch, etc. Designers may change the design of the panel 111 according to demands, so the disclosure does not limit it.

The embedded filter 20 includes a hollow cylinder 21 and a filter element 22 disposed in the hollow cylinder 21. The hollow cylinder 21 may be assembled or removed corresponding to the installing hole 111 from the outside of the panel 11. In some embodiments, the hollow cylinder 21 is a transparent member so that the degree of dirtiness of the filter element 22 may be directly viewed from the outside. The inside of the hollow cylinder 21 is provided with an air outlet pipe 211 and an outer connector 212 communicating with the air outlet pipe 211. Multiple air inlet openings 213 are formed between the air outlet pipe 211 and the outer connector 212. The outer connector 212 is used for connecting the soft tube (not shown in figures) to cooperate with the vacuum cup (not shown in figures) so as to guarantee the filter is used to suck or eject air when a user is using and is easy to be removed or replaced for the user. In the embodiment, the filter element 22 is, but not limited to, a cylindrical cotton filter. The filter element 22 is adapted to sheathe the outer periphery of the air outlet pipe 211 and fixed between the hollow cylinder 21 and the air outlet pipe 211. In some embodiments, an inner wall of the hollow cylinder 21 is protruded with multiple holding ribs 214 so that when the filter element 22 is fixed in the hollow cylinder 21, a periphery of the filter element 22 is slightly deformed by the holding ribs 214 and the hold the filter element 22 is firmly held in the hollow cylinder 21.

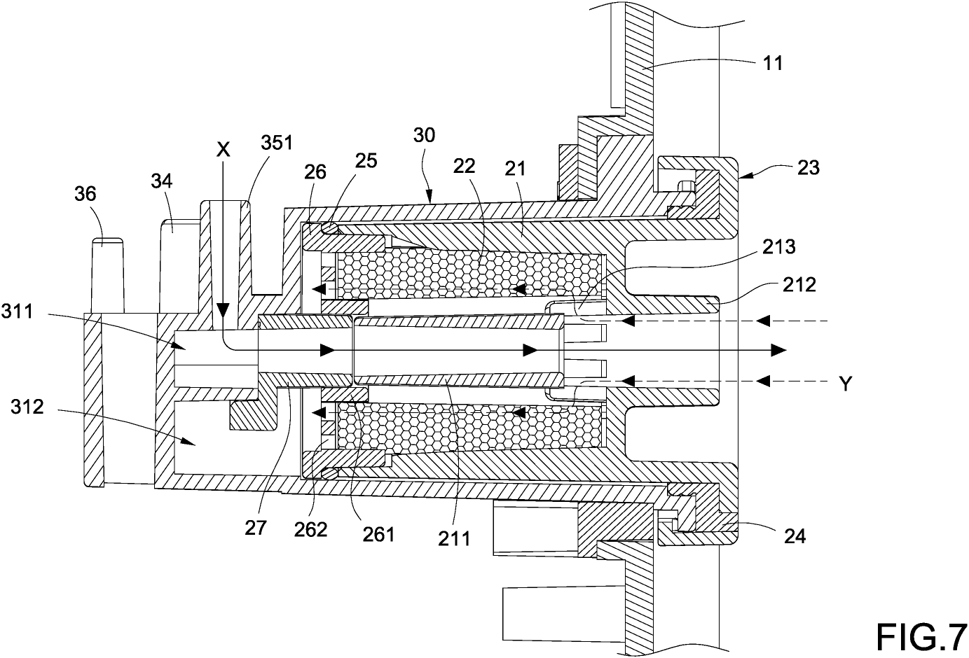

Further, the negative-pressure massage machine of the disclosure includes an adapter 30. The adapter 30 passes through and is fixed to the installing hole 111 for the embedded filter 20 to be sheathed and fastened. In the embodiment, the adapter 30 is fixed on the panel 11 by multiple screws A. In detail, the adapter 30 has a chamber 31 and an aperture 32 communicating with the chamber 31. The aperture 32 is located at an end of the adapter 30 projecting from the panel 11. An outer edge of the aperture 32 is formed with a connecting portion 33. Please refer to FIG. 7. The adapter 30 further includes a communicating element 27 disposed in the chamber 31. The hollow cylinder 21 is received in the chamber 31. An end of the hollow cylinder 21 is protruded with an engaging portion 23 corresponding to and engaging with the connecting portion 33. In the embodiment, the engaging portion 23 is formed with multiple latching lugs 231. The connecting portion 33 is formed with multiple locking recesses 331 separately corresponding to the latching lugs 231. Rotating the embedded filter 20 may make each latching lug 231 latched in corresponding one of the locking recesses 331 so as to fasten the embedded filter 20 in the adapter 30.

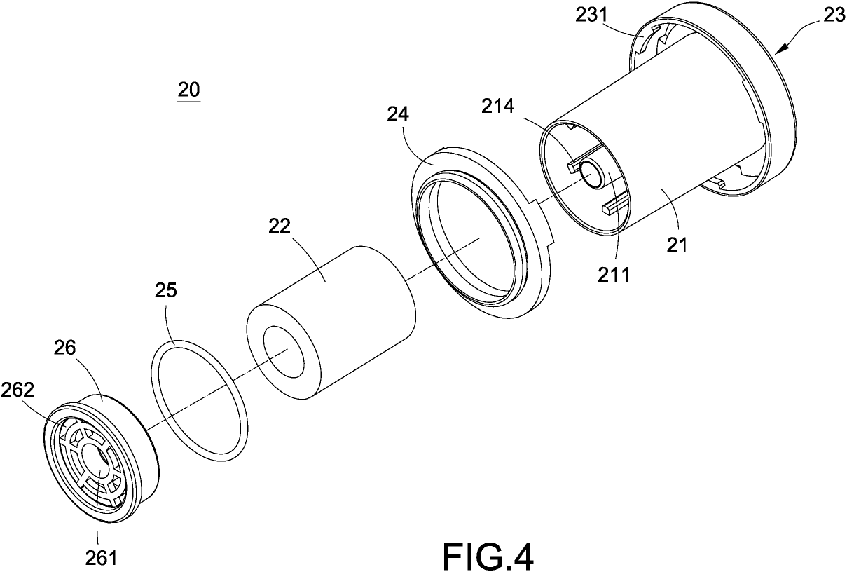

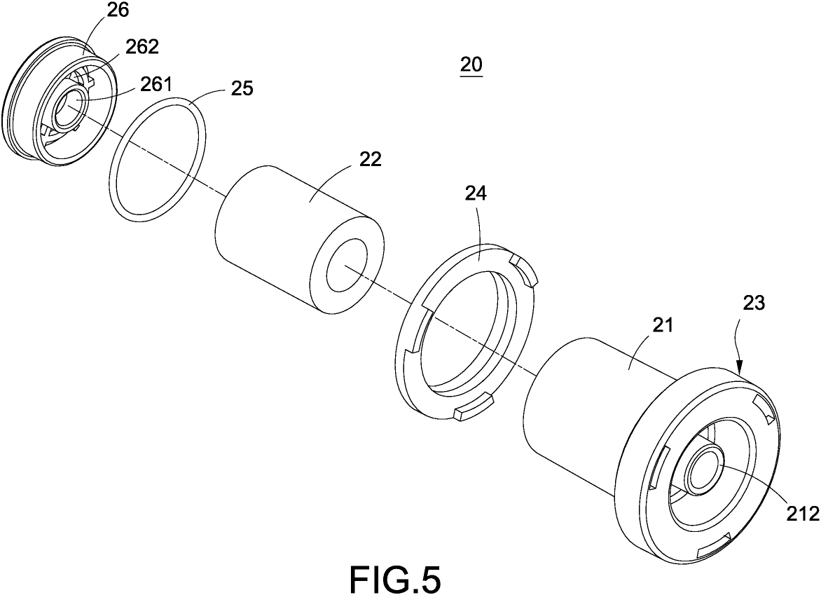

Please refer to FIGS. 4 and 5. The embedded filter 20 further includes an air sealing ring 24, a rubber ring 25 and a venting cover 26. The air sealing ring 24 is substantially of an annular shape and disposed in the engaging portion 23. When the embedded filter 20 is fixed in the adapter 30, the air sealing ring 24 is tightly clamped between the engaging portion 23 and the connecting portion 33 to accomplish the effect of sealing. The rubber ring 25 is substantially of an annular shape and is adapted to sheathe the venting cover 26. The venting cover 26 is plugged on an end of the hollow cylinder 21 to block the filter element 22 between the hollow cylinder 21 and the venting cover 26 and prevent the filter element 22 from escaping the embedded filter 20. The rubber ring 25 is tightly clamped between the hollow cylinder 21 and the venting cover 26 to accomplish sealing and guarantee no air leakage. The center of the venting cover 26 is formed with a through hole 261 for the communicating element 27 to pass and be fixed. Also, the venting cover 26 is formed with multiple vents 262 on the periphery of the through hole 261 so that the air filtered by the filter element 22 may flow out of the embedded filter 20 through the vents 262.

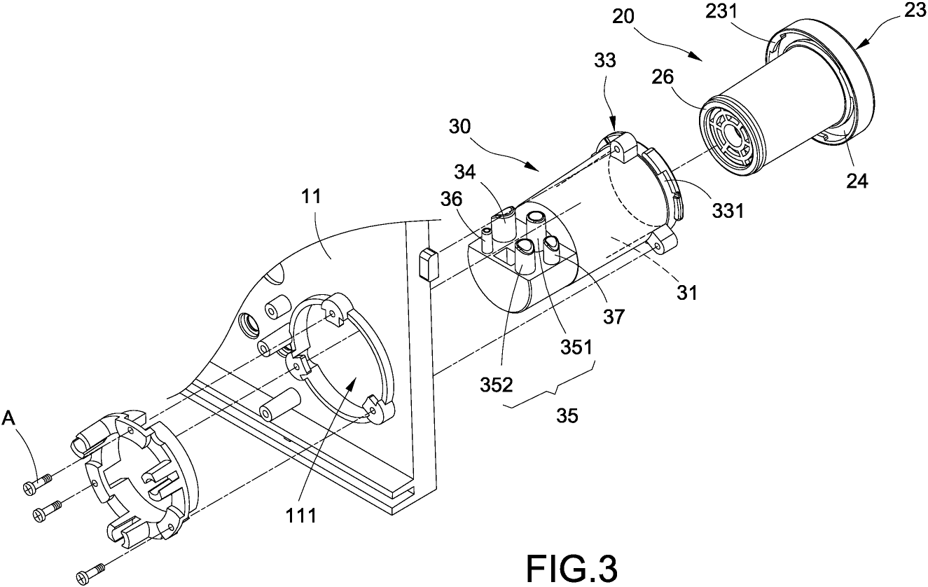

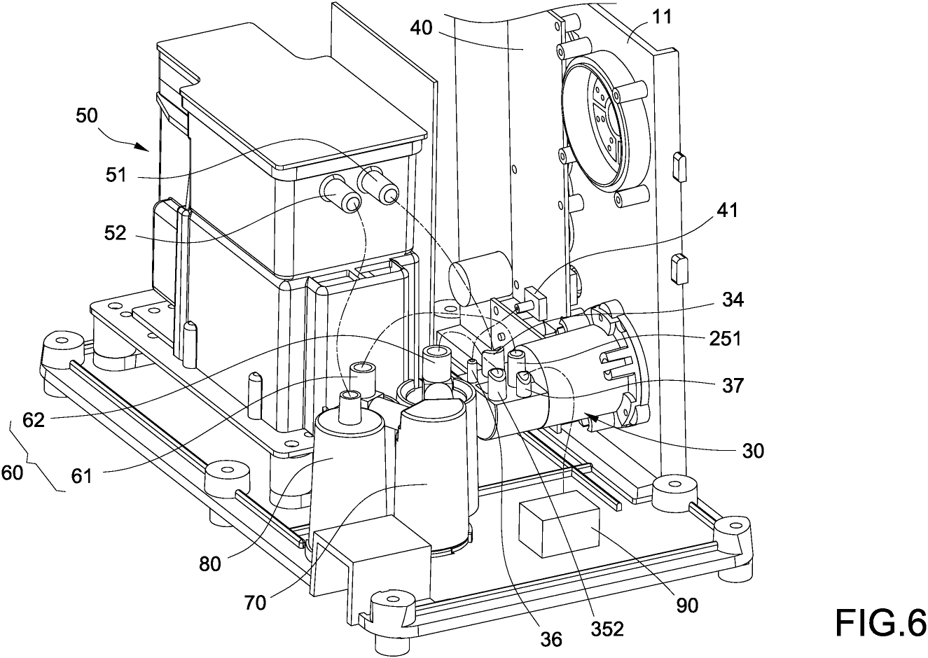

Please refer to FIG. 3. An end of the adapter 30, which is opposite to the aperture 32, is formed with a sucking connector 34, at least one leaking connector 35, an air pressure detecting connector 36 and a negative ion emitting connector 37. In the embodiment, the leaking connector 35 is two in number. The two leaking connectors 35 are, but not limited to, a high-flow leaking connector 351 and a low-flow leaking connector 352. The high-flow leaking connector 351, the low-flow leaking connector 352 and the negative ion emitting connector 37 communicate with one another, and the sucking connector 34 communicates with the air pressure detecting connector 36. Please refer to FIG. 6. The negative-pressure massage machine of the disclosure further includes a circuit board 40, a pressure detecting module 41, a vacuum pump 50, at least one electromagnetic valve 60, an air inlet bar 70, an air outlet bar 80, a negative ion generator 90 and multiple connecting tubes (shown by broken lines for simplification). In the embodiment, the electromagnetic valve 60 is two in number. The two electromagnetic valves 60 are, but not limited to, a high-flow electromagnetic valve 61, and a low-flow electromagnetic valve 62.

In detail, the vacuum pump 50 is used to suck air for a vacuum cup (not shown in figures). The vacuum pump 50 has an air inlet hole 51 and an air outlet hole 52. The air inlet hole 51 is connected to the sucking connector 34 and the air outlet hole 52 is connected to the air outlet bar 80, so that the gas sucked by a vacuum cup (not shown in figures) and filtered by the embedded filter 20 may be ejected to outside of the main body 10 by the vacuum pump 50 through the air outlet bar 80. The pressure detecting module 41 is disposed on the circuit board 40 and connected to the air pressure detecting connector 36 to measure the vacuum degree when the vacuum cup (not shown in figures) is sucking air. A user may read the value through the display on the panel 11. The high-flow electromagnetic valve 61 is connected to the high-flow leaking connector 351 and the low-flow electromagnetic valve 62 is connected to the low-flow leaking connector 352. Both the high-flow electromagnetic valve 61 and the low-flow electromagnetic valve 62 communicate with the air inlet bar 70. Therefore, the gas sucked by the air inlet bar 70 may be ejected through different leaking connectors 35 depending on demands to achieve a change of air ejection flow. The negative ion generator 90 is connected to the negative ion emitting connector 37 so as to eject the negative ions generated by the negative ion generator 90 and the gas ejected by any one of the leaking connector 35 to further enhance the function of massage.

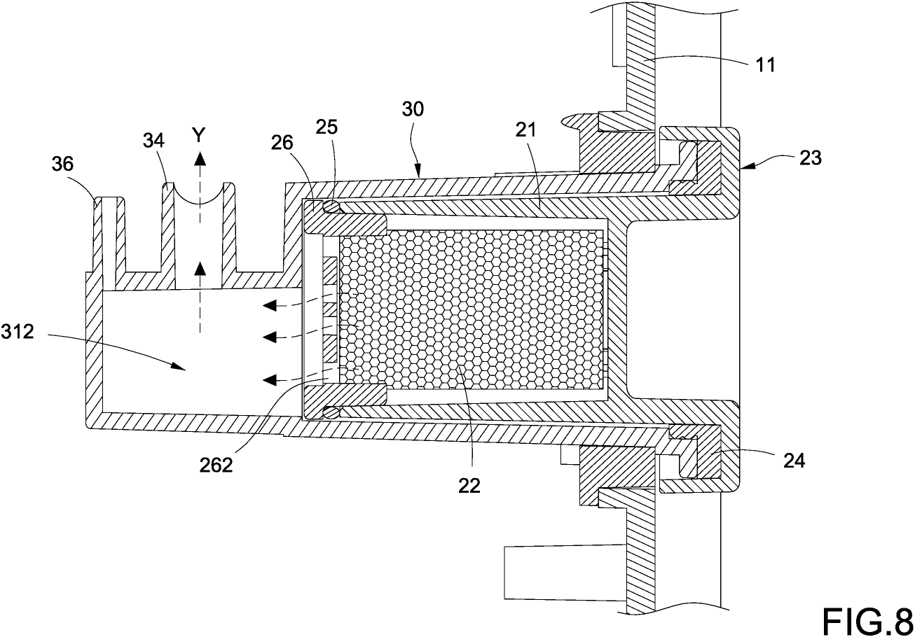

Please refer to FIGS. 7 and 8. A distal end of the chamber 31 is divided into an air outlet chamber 311 and an air inlet chamber 312. The air outlet chamber 311 communicates with the high-flow leaking connector 351, the low-flow leaking connector 352 and the negative ion emitting connector 37. The air inlet chamber 312 communicates with the sucking connector 34 and the air pressure detecting connector 36. When the embedded filter 20 is installed in the chamber 31 of the adapter 30, the through hole 261 of the venting cover 26 is passed by the communicating element 27 to make the communicating element 27 and the air outlet pipe 211 communicate with each other. As a result, the outer connector 212, the air outlet pipe 211, the communicating element 27, the air outlet chamber 311 and the leaking connector 35 jointly form an air outlet channel X, and the outer connector 212, each air inlet opening 213, the filter element 22, each vent 262, the air inlet chamber 312 and the sucking connector 34 jointly form an air inlet channel Y. Therefore, the air outlet channel X and the air inlet channel Y are two independent channels so that the oily dirt filtered by the filter element 22 may not be re-ejected when ejecting air.

Moreover, when sucking air, the air flows through the air inlet channel Y of the embedded filter 20, its complete path is described as follows. Air enters though the outer connector 212 of the embedded filter 20, then flows in between the hollow cylinder 21 and the air outlet pipe 211 through the air inlet openings 213 and is filtered by the filter element 22 to filter out impurities such as oily dirt, next flows through the venting cover 26 and then enters the air inlet chamber 312 of the adapter 30 and leaves the adapter 30 through the sucking connector 34, and finally passes the vacuum pump 50 and is ejected to outside of the main body 10 through the air outlet bar 80.

In detail, when ejecting air, the air flows through the air outlet channel X of the embedded filter 20, its complete path is described as follows. Air is sucked from the outside of the main body 10 through the air inlet bar 70, then flows to corresponding one of the high-flow leaking connector 351 and the low-flow leaking connector 352 through either the high-flow electromagnetic valve 61 or the low-flow electromagnetic valve 62, next enters the air outlet chamber 311 and then flows through the communicating element 27 and the air outlet pipe 211 in order, and finally is ejected to the vacuum cup (not shown in figures) from the outer connector 212 through the soft tube (not shown in figures).

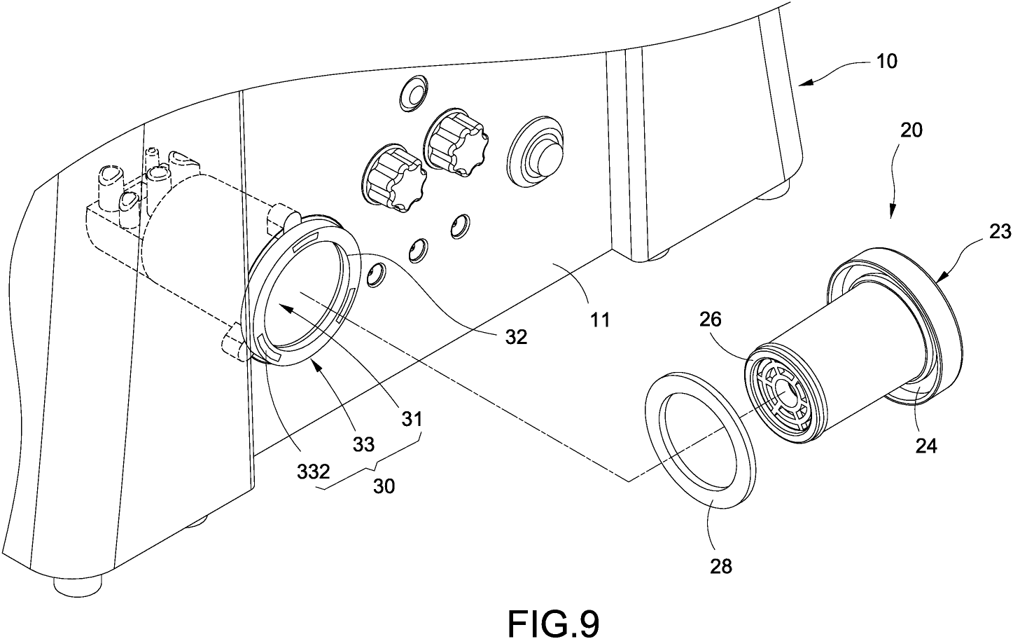

Please refer to FIG. 9, which shows another embodiment of the disclosure. Its main difference is the connection between the engaging portion 23 and the connecting portion 33. In the embodiment, a first magnetic element 28 is disposed in the engaging portion 23 and the connecting portion 33 is provided with multiple second magnetic elements 332. The first magnetic element 28 and each second magnetic element 332 attract each other so that the engaging portion 23 and the connecting portion 33 may be easily connected and separated by a user. In detail, the first magnetic element 28 is an annular sheet. The first magnetic element 28 is adapted to sheathe the hollow cylinder 21 and is received in the engaging portion 23. Each second magnetic element 332 is a block embedded in the connecting portion 33. The first magnetic element 28 and the second magnetic elements 332 may be two kinds of magnets with opposite polarity or a combination of a magnet and a magnetic metal, the disclosure does not limit to this, the requirement is that the two may magnetically attract each other.

While this disclosure has been described by means of specific embodiments, numerous modifications and variations could be made thereto by those skilled in the art without departing from the scope and spirit of this disclosure set forth in the claims.

What is claimed is:

1. A negative-pressure massage machine comprising:
a main body, comprising a panel with an installing hole; and
an embedded filter, comprising a hollow cylinder and a filter element disposed in the hollow cylinder, and the hollow cylinder assembled or removed corresponding to the installing hole from an outside of the panel.

2. The negative-pressure massage machine of claim 1, further comprising an adapter, wherein the adapter passes through and is fixed to the installing hole, a connecting portion is disposed on one end of the adapter projecting from the panel, the hollow cylinder is received in the adapter, an engaging portion is disposed protrusively on an end of the hollow cylinder, and the engaging portion is engaged with the connecting portion correspondingly.

3. The negative-pressure massage machine of claim 2, wherein the engaging portion comprises multiple latching lugs disposed thereon, the connecting portion comprises multiple locking recesses separately corresponding to the latching lugs, and each latching lug is latched to each locking recess correspondingly to fasten the embedded filter in the adapter by rotating the embedded filter.

4. The negative-pressure massage machine of claim 2, wherein a first magnetic element is disposed in the engaging portion, the connecting portion comprises multiple second magnetic elements, and the first magnetic element and each second magnetic element attract each other to make the engaging portion and the connecting portion be connected.

5. The negative-pressure massage machine of claim 2, wherein the hollow cylinder comprises an air outlet pipe disposed therein and an outer connector communicating with the air outlet pipe, and the filter element is adapted to sheathe the air outlet pipe.

6. The negative-pressure massage machine of claim 5, wherein the embedded filter further comprises a venting cover plugged on the hollow cylinder to block the filter element.

7. The negative-pressure massage machine of claim 6, wherein a sucking connector and a leaking connector are disposed on another end of the adapter away from the connecting portion, the adapter further comprises a communicating element passing through the venting cover to communicate with the air outlet pipe and dividing an inside of the adapter to an air outlet chamber and an air inlet chamber, the leaking connector communicates with the air outlet chamber, and the sucking connector communicates with the air inlet chamber.

8. The negative-pressure massage machine of claim 7, wherein an air outlet channel is configured jointly by the outer connector, the air outlet pipe, the communicating element, the air outlet chamber, and the leaking connector.

9. The negative-pressure massage machine of claim 7, wherein the venting cover comprises multiple vents, multiple air inlet openings are disposed between the air outlet pipe and the outer connector, and air inlet channel is jointly configured by the outer connector, each air inlet opening, the filter element, each vent, the air inlet chamber, and the sucking connector.

10. The negative-pressure massage machine of claim 7, further comprising a negative ion generator, wherein a negative ion emitting connector is further disposed on the another end of the adapter away from the connecting portion, and the negative ion emitting connector communicates with the air outlet chamber to eject a negative ion generated by the negative ion generator from the negative ion emitting connector to the air outlet chamber.

11. The negative-pressure massage machine of claim 7, further comprising a pressure detecting module, an air pressure detecting connector is further disposed on the another end of the adapter away from the connecting portion, the air pressure detecting connector communicates with the air inlet chamber, and a vacuum degree is measured by the pressure detecting module when sucking air.

12. The negative-pressure massage machine of claim 5, wherein the hollow cylinder comprises multiple holding ribs disposed protrusively on an inner wall thereof, and each holding rib is fastened with the filter element.

13. The negative-pressure massage machine of claim 6, wherein the embedded filter further comprises an air sealing ring and a rubber ring, the air sealing ring is disposed in the engaging portion and clamped between the engaging portion and the connecting portion, the rubber ring is adapted to sheathe the venting cover and clamped between the hollow cylinder and the venting cover.

14. The negative-pressure massage machine of claim 1, wherein the hollow cylinder comprises a transparent member.
